(19) United States
(12) Patent Application Publication
(10) Pub. No.: US 2003/0046956 A1
(43) Pub. Date: Mar. 13, 2003

(54) Method and apparatus for crucible forming

(76) Inventors: James G. Anderson, Dundee, NY (US); John P. Nicholson, Horseheads, NY (US)

Correspondence Address: CORNING INCORPORATED, SP-TI-3-1, CORNING, NY, 14831

(21) Appl. No.: 09/943,255

(22) Filed: Aug. 30, 2001

(51) Int. Cl. C03B 20/00; C03B 21/02

(52) U.S. Cl. 65/108; 65/403; 65/109

(57) ABSTRACT

The present invention relates to a method of forming a crucible. The method includes the steps of (a) bottoming one end of a tube thereby forming a substantially closed end; (b) heating the closed end to a forming temperature; (c) contacting an interior surface of the closed end with a forming tool, thereby altering the interior surface of the closed end to form at least one section with a predetermined wall thickness; and (d) manipulating the at least one section of the closed end to form an orifice.

### BACKGROUND OF THE INVENTION

1. Field of the Invention

The present invention relates generally to optical fiber (hereinafter “fiber”) and more particularly to a method for forming a crucible for a multiple crucible optical fiber draw apparatus.

2. Technical Background

The most widely known multiple crucible method of drawing fiber is the double crucible method. The double crucible method of making fiber has been known for at least the last two or three decades, and is disclosed for example in Optical Fibers for Transmission, New York John Wiley, pp. 166-178 (Midwinter, 1979).

In the past, the double crucible method has been used in the area of drawing multimode fiber. The double crucible exploited the natural tendency of the fiber core and cladding to diffuse (mix). This type of fiber is typically characterized as a fiber with a large core relative to the cladding and a less than step function refractive index change at the interface of the core and cladding (hereinafter multimode fiber). Later work in this area was directed toward creating a parabolic index profile in the multimode fiber. This was accomplished by controlling the diffusion between the core and the cladding. The multimode fiber was composed of a fiber having a core region with a circular cross section and a cladding that was concentrically located around the core.

Previous attempts to make the orifice of a crucible for double draw apparatus included an exterior molding process. A mold for the crucible was externally heated and molten glass was blown into the mold. The above process may not be used to produce a crucible with an orifice with a diameter of less than 0.6 mm. Also, the wall thickness of the molded crucible was not uniform. Therefore, it is desirable to have a method to form a crucible with an orifice diameter of 0.5 mm or less and that may be used to control the wall thickness of the crucible.

### SUMMARY OF THE INVENTION

The present invention relates to a method of forming a crucible. The method includes the steps of (a) bottoming one end of a tube thereby forming a substantially closed end; (b) heating the closed end to a forming temperature; (c) contacting an interior surface of the closed end with a forming tool, thereby altering an interior surface of the closed end to form at least one section with a predetermined wall thickness; and (d) manipulating the at least one section of the closed end to form an orifice.

Practicing the above method to form a crucible will result in the advantages of being able to produce multiple crucibles with the same orifice geometry, improve glass flow, and melting characteristics of raw materials in a multiple crucible fiber draw process. The method may be used to produce a crucible which may be used to draw a fiber with a non-circular cross section. The method may also be used to optimize glass wall thickness for tip strength as well as advantageous glass flow. The invention may also be used to manufacture a crucible for a multiple crucible to enhance the clearance between concentric crucibles in close proximity to one another. Further advantages of practicing the above method include the ability to produce a crucible with a non-symmetrical shape and the ability to control the internal dimensions of the crucible. Practicing the inventive method will result in the ability to easily reproduce multiple crucibles with the same orifice geometry.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a plan view of a tube which may be used to practice the present invention.

FIG. 2 is a plan view of the tube after one end of the tube has been closed in accordance with the invention.

FIG. 3 is a plan view of a forming tool and the tube generated by practicing a method of the present invention.

FIG. 4 is a plan view of a crucible generated by practicing a method of the present invention.

FIG. 5 is a plan view of the crucible generated by practicing a method of the present invention.

FIG. 6 is a plan view of a forming tool for venting an atmosphere from the inside of the tube in accordance with the present invention.

FIGS. 7-9 are cross sectional views of samples made in accordance with the invention having at least one section with at least one substantailly non-circular cross-section.

FIGS. 10 and 11 are elevated side views of a forming tool with and without a nipple.

FIG. 12 is an elevated side view of a forming tool having a nipple.

FIG. 13 is a cross sectional view of a fiber with an inner section with a peanut shaped portion.

FIG. 14 is an elevated side view of the heating of a tube with a burner in accordance with the invention.

### DETAILED DESCRIPTION OF THE INVENTION

Reference will now be made in detail to the present preferred embodiments of the invention, examples of which are illustrated in the accompanying drawings. Wherever possible, the same reference numbers will be used throughout the drawings to refer to the same or like parts.

Exemplary embodiments of a multiple crucible draw apparatus which may be used to practice the present invention include at least a double crucible draw apparatus or a triple crucible draw apparatus. The present invention is applicable to any and all multiple crucible draw processes. For example the invention is equally applicable to a quad crucible. One factor in determining a preferable number of crucibles is the number of distinct layers of glass required in the fiber. For example, for a fiber with a simple step index core and a cladding, a double crucible draw apparatus may be preferred. For a fiber with a multi-segment core and a cladding, a triple crucible draw apparatus may be preferred. The present invention may be practiced to draw an optical fiber from the multiple crucible apparatus or an optical fiber cane from the apparatus. Soot may be deposited on the cane by various chemical vapor deposition techniques, such as OVD and VAD. The soot coated cane may subsequently be drawn into a fiber.

In accordance with the present invention, preferably at least one of the crucibles in a multiple crucible is made in accordance with the present invention. However, the present invention may be used to manufacture more than one of the crucibles in the multiple crucible apparatus. For illustrative purposes, in one embodiment of a triple crucible, the middle crucible is made in accordance with the invention.

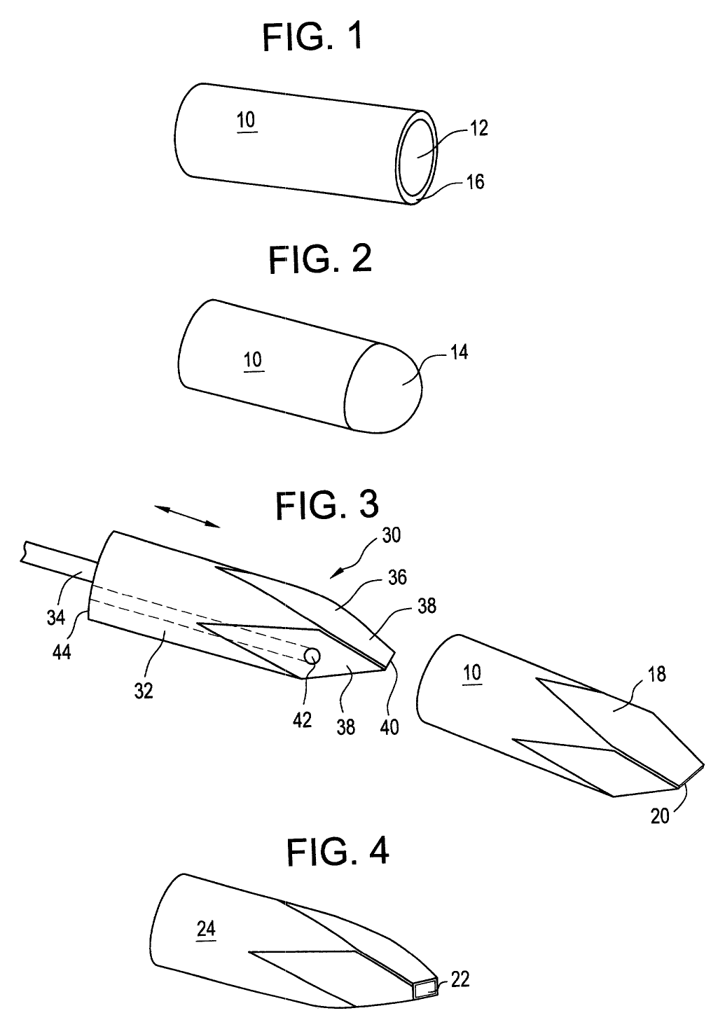

The present invention includes a method of forming a crucible. As illustrated in FIGS. 1-4, the method includes bottoming one end of a tube 10. Tube 10 is not required to be cylindrical, as shown. A non-exhaustive list of potential shapes of tube 10 includes square, rectangular, or triangular. Preferably the tube has at least one open end 12, more preferably at least two open ends. Preferably tube 10 is constructed from a material that is capable of decreasing in viscosity. One type of preferred material is glass, such as quartz glass. Preferably the quartz glass is a silicate glass that comprises at least about 90% silica, more preferably at least about 95% silica, and most preferably at least about 99% silica. It is also preferred that the material is able to withstand a temperature of at least about 1700° C. Tube 10 is not limited to any particular diameter. The outer diameter of tube 10 can range from about 75 mm to about 3 mm, preferably about 54 mm to about 6 mm. The invention is not limited to tube 10 having any particular outer diameter. A source of tube 10 is Technical Glass Products, Inc. of Mentor, Ohio. Preferred properties of tube 10 are listed in table A below.

TABLE A
Property

| | | |
|---|---|---|
| Density | 2.2 gm/cm³ | 2.2 × 10³ kg/m³ |
| Hardness | 5.5-6.5 Mohs | |
| Design Tensile | 7,000 psi | 4.8 × 10⁷ Pa |
| Strength | | |
| Design Compressive | >160,000 psi | >1.1 × 10⁹ Pa |
| Strength | | |
| Bulk Modulus | 5.3 × 10⁶ psi | 3.7 × 10¹⁰ Pa |
| Rigidity Modulus | 4.5 × 10⁶ psi | 7.2 × 10¹⁰ Pa |
| Young's Modulus | 10.5 × 10⁶ psi | 7.2 × 10⁶ Pa |
| Poisson's Ratio | .17 | .17 |
| Coefficient of | 5.5 × 10⁻⁷ · cm/cm · ° C. | 5.5 × 10⁻⁷ m/m · ° K. |
| Thermal Expansion | | |
| Thermal Conduc- | 3.3 × 10⁻³ gm | 1.4 W/m · ° K. |
| tivity (20° C.) | cal · cm/· cm² · sec · ° C. | |
| Specific Heat | .16 gm cal/gm | 670 J/kg · ° K. |
| (20° C.) | | |
| Softening Point | 1683° C. | 1956° K. |
| Annealing Point | 1215° C. | 1488° K. |
| Strain Point | 1120° C. | 1393° K. |
| Electrical Resistivity | 7(10⁹) ohm · cm | 7(10⁷) ohm · m |
| Dielectric Properties | (20° C. and 1 Mc) | (293° K. and 1 MHz) |
| Constant | 3.75 | 3.75 |
| Strength | 1270 volts/mil | 5 × 10⁷ V/m |
| Loss Factor | <4 × 10⁻⁴ | <4 × 10⁻⁴ |
| Dissipation Factor | <1 × 10⁻⁴ | <1 × 10⁻⁴ |
| Index Refraction | 1.4585 | 1.4585 |
| Constrigence (Nu | 67.56 | 67.56 |
| value) Fused Quartz | | |
| Velocity of Sound- | 3.75 × 10⁵ cm/sec | 3.75 × 10³ m/s |
| Shear Wave | | |
| Velocity of Sound | 5.90 × 10⁵ cm/sec | 5.90 × 10³ m/s |
| Compressional | | |
| Wave | | |
| Sonic Attenuation | <.033 db/ft · Mc | <.11 db/m · MHz |
| Permeability | (cm³ · mm/cm² · sec · cm | |
| Constants | of Hg—700° C./973° K.) | |
| Helium | 210 × 10⁻¹⁰ | |
| Hydrogen | 21 × 10⁻¹⁰ | |
| Deuterium | 17 × 10⁻¹⁰ | |
| Neon | 9.5 × 10⁻¹⁰ | |

Glass lamp working techniques may be used to bottom end 12 of tube 10. In glass lamp working, end 12 of tube 10 is heated to at least a softening point of the material of construction of tube 10. Preferably tube 10 is rotated during the bottoming step. Tube 10 may or may not be internally pressurized during the bottoming step. It is preferred that the tube 10 is heated with a dry heat source. However the invention is not limited to flame working with only a dry heat source. Alternatively, the heat source could be an induction coil. The induction coil may have a graphite heating element. The induction coil may be disposed on the inside or the outside of tube 10.

Once end 12 of tube 10 is heated to at least its softening point, end 12 of tube 10 may be closed and preferably manipulated into the shape of one-half of a sphere connected to tube 10, FIG. 2.

Optionally, the tube 10 may be internally pressurized during heating of end 12. Pressurizing tube 10 during heating prevents sagging of any heated section of tube 10. Any inert gas may be used to pressurize tube 10, such as nitrogen, helium, argon, or any other inert gas. This may also aid in maintaining a constant outer diameter of tube 10.

Optionally, in the case of heating tube 10 with a nondry heat source, an additional step of drying tube 10 may be practiced to remove any residual water formed on tube 10. The drying of tube 10 may be accomplished by passing a dry gas around tube 10. This step may be also be practiced if a dry heat source is used.

Lamp working may also be used to manipulate the thickness of wall 16 to a predetermined amount. Lamp working may be used to reduce the wall thickness from between more than 0% to up to about 90%. Typically tube 10 has a wall thickness of about 5 mm or less, preferably about 3 mm less, and more preferably about 2 mm or less. Tube 10 may have a wall thickness of about 1 mm or less. The wall of tube 10 may be thinned to a range of about 4.5 mm to about 0.25 mm. An example, of a suitable wall thickness for one embodiment of tube after, tube 10 has been thinned is about 0.5 mm. To manipulate the thickness of the wall 16, a section of tube 10 is heated. The heated section of tube 10 is pulled in an axial direction away from tube 10. Pulling may also be defined as a stretching, attenuating, or elongation of the heated section of tube 10. Preferably, the bottomed end of tube 10 is closed end 14. Preferably closed end 14 has the shape of half of a sphere 14.

An example of one embodiment of the bottoming step includes clamping tube 10 in a lamp working lath. The chucks should be placed as close to the area to be heated as possible to minimize runout. During heating, tube 10 should be rotated at such a rate that during heating, the area being heated does not sag (rotating to slow) or the diameter of tube 10 does not expand (rotating to fast). For a tube with a diameter of about 35 mm, a preferred rate of rotation is about 60 rpm.

Preferably, tube 10 is heated with a burner. A preferred burner is a hydrogen oxygen burner. Initially it is preferred that the ratio of hydrogen to oxygen in the flame is about 1:1. Typically, at the ratio of 1:1, the flame is referred to as a fluffy fire, meaning the flame does not have primary and secondary cones. Then the flame is positioned to heat a region of tube 10, such as end 12. Heating of end 12 causes the glass to soften and reduces the diameter of end 12. The reduction in diameter of end 12 may also be referred to as “necking”. Preferably tube 10 is rotated during the heating. Generally during the necking process, the flame velocity is increased. One technique to increase the flame velocity is to increase the ratio of oxygen to hydrogen in the flame. The ratio of oxygen to hydrogen in the flame is increased from about 1:1 up to about 4:1. Preferably, the increase is at least up to about 2:1. A flame with an oxygen ratio of at least 2:1 may have defined primary and secondary cones. The heating of end 12 continues until end 12 has a substantially hour glass shape. Preferably, end 12 is symmetrical.

An advantageous use of a flame having an oxygen ratio of greater than 1:1 is to heat a predetermined point of tube 10. A flame having the aforementioned oxygen to hydrogen ratio may be used to apply heat to one portion of tube 10 to heat the portion to a point at which the glass may flow. The flowing of the glass may cause the reduction in diameter of the tube 10 and/or a reduction in wall thickness.

The necking of end 12 may be enhanced by using a carbon rod to apply pressure to end 12. Preferably the rod is heated to a temperature of less than about 1600° C., more preferably less than about 1000° C., even more preferably no more than about 700° C., and most preferably up to about 500° C. Preferably the rod is not at a temperature at which particles from the rod will adhere to a glass surface of tube 10 when the rod is in contact with tube 10. Once the temperature of the rod has reached the appropriate level, the rod may be used to apply a pressure to the glass at a particular point of the surface of tube 10. Contacting the surface of tube 10 with the rod will cause tube 10 to deform at the contact point with the rod. While the rod and tube 10 are in contact, preferably tube 10 is at least 1700° C. at the contact point. The above use of the rod is a technique that may be used to reduce the diameter of tube 10.

During the heating step, the wall thickness of end 12 may be altered by the positioning of the burner and the heating location. The wall thickness may be increased by positioning the burner at an acute angle to tube 10 (as shown in FIG. 14) and increasing the flame velocity. Flame velocity may be increased by increasing the ratio of oxygen to hydrogen in the flame, as discussed above. This will cause the glass to flow in a direction away from the point at which the burner applies the heat to tube 10, in at least the axial direction of arrow A. The flow of glass may also be described as in the direction of the flame. The wall thickness may be thinned by concentrating the heat in one area and subsequently moving the burner in an axial direction. The glass that is heated will move in a direction away from the burner.

Optionally, further necking of end 12 may be achieved by applying pressure to end 12 with a carbon rod in the same manner as described above. Eventually, end 12 has been heated and necked to a fiber like dimension and the hour glass portion of tube 10 severs from tube 10 and closed end 14 remains. Fiber like dimension is used above to describe a dimension of tube 10 for which the flame of an oxygen hydrogen burner may be used to radially vaporize the glass or a glass segment that may be broken off from closed end 14 of tube 10.

If the glass “beads up” and closed end 14 has at least one portion that has a thickness that is greater than desired, the portion can be thinned. The portion of closed end 14 to be thinned is simultaneously heated with a glass cane, preferably quartz glass. Once the portion and the cane has reached about 1700° C. to about 2100° C., the portion and the cane are brought into contact and tube 10 and the cane are rotated, such that the excess glass of the portion is gathered on the cane.

Optionally, further shaping of closed end 14 may occur by the use of a carbon tool known as a “paddle”. Preferably the paddle is the shape of the desired contour of closed end 14. The paddle may be used to shape closed end 14 by applying pressure to end 14 once end 14 has been heated to a molten state and the tube 10 is rotating.

A further optional method to shape closed end 14 is through the use of internal pressure. A rubber stopper, rotating joint and rubber tubing is applied to an open end of tube 10 opposite closed end 14. Air at a pressure of no more than about 2 psi, (preferably no more than about 1.5 psi, and, more preferably no more than about 1.0 psi) is blown into tube 10 through the rubber tubing while closed end 14 is in a pliable state. The air pressure will expand the diameter of at least the hottest area of closed end 14. The above techniques may be used in any possible combination with one another.

Preferably at least closed end 14 is heated to a forming temperature. The forming temperature may be above the softening point for the material of construction of end 14. Preferably the forming temperature is at least 100° C. above the softening point of the material of tube 10 and more preferably about 200 to about 300° C. above. Preferably tube 10 is rotated during the heating to the forming temperature. In the case of a quartz tube, the forming temperature is about 1900 to about 2500° C., preferably about 2000 to about 2300° C.

The method further includes contacting an interior surface of closed end 14 with a forming tool 30, thereby altering an interior surface of the closed end to form at least one section with a predetermined wall thickness. Preferably, the step of contacting may include plunging tool 30 into an open end of tube 10 toward closed end 14 of tube 10. Contacting closed end 14 with tool 30 may result in closed end 14 further including an end 18 and a tip 20.

Preferably, forming tool 30 is constructed from a conductive material. The material of tool 30 is preferably capable of absorbing heat from tube 10. Examples of a preferred material of construction of tool 30 are graphite, platinum, alloys of platinum, alumina, zirconia, titania, ceramics, and combinations thereof. Macor® is an example of a preferred ceramic, available from Coming Incorporated of Corning, N.Y. Preferably tool 30 includes a main body 32 attached to handle 34. Main body 32 includes a forming end 36 with at least one non-circular surface 38, preferably a plurality of non-circular surfaces 38. Preferably, non-circular surfaces 38 are tapered to a tip 40. Preferably, surfaces 38 are tapered at a draft angle of at least about 2% or more, more preferred at least about 5% or more, even more preferred at least about 7% or more, and most preferred at least about 10% or more. Preferably tip 40 is not a point. It is also preferred that tip 40 is non-circular. Tip 40 may be composed of the same material as body 32 or tip 40 may be composed of a different material of construction than body 32. In one embodiment of tool 30, body 32 is composed of graphite and tip 40 is composed of platinum or a platinum alloy.

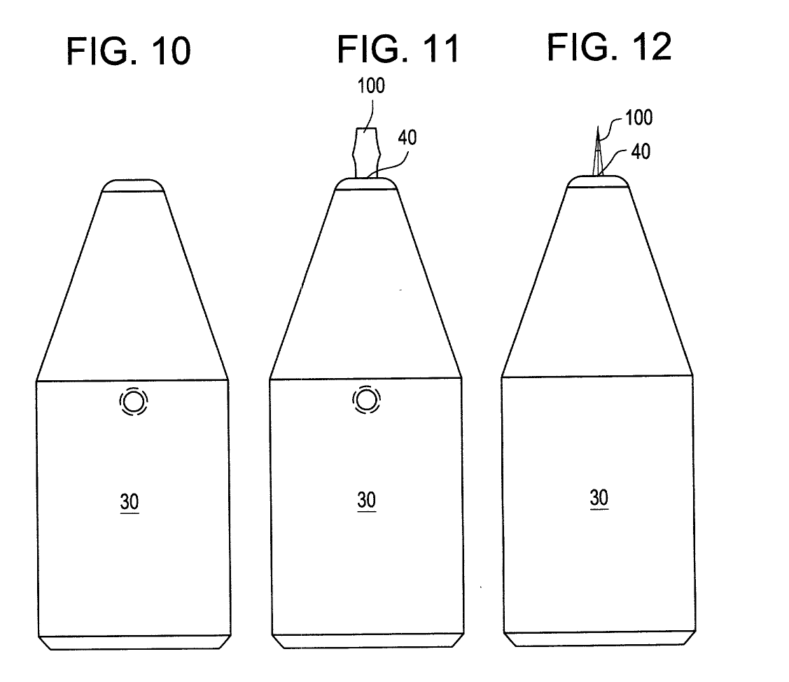

Two different embodiments of tool 30 are illustrated in FIGS. 10-12. In FIG. 10, tool 30 does not include a nipple 100, unlike FIGS. 11 and 12. As illustrated in FIGS. 11 and 12, nipple 100 extends from tip 40. Nipple 100 is illustrated in the shape of the head of a regular screwdriver. However, nipple 100 is not limited to any particular shape or size. Also nipple 100 may be constructed from the same material as the rest of forming tool 30 or a different material than the rest of forming tool 30. Preferred materials of construction of nipple 100 include graphite, platinum, alumina, zirconia, ceramics, or combination thereof. Nipple 100 may be integral or attached to forming tool 30.

Forming tool 30 having nipple 100 may be used to form a crucible having an orifice with a high aspect ratio, at least about 3:1. An advantage of using tool 30 with nipple 100 is that tip 40 can be used as a stop for tool 30, such that tool 30 may not be plunged to far into closed end 14.

Preferably an inner diameter of tube 10 comprises no more than about 5% more than an outer diameter of the forming tool, more preferably no more than about 4%, even more preferably no more than about 3%, and most preferably no more than about 2%. It is preferred if the diameter of forming tool 30 is within about 1% to about 2% of the inner diameter of tube 10.

Preferably the time period for the contacting period is short. Preferably, tool 30 is in contact with tube 10 for less than about 10 seconds, more preferably less than about 5 seconds, even more preferably no more than about 3 seconds, and most preferably no more than about 2 seconds.

Optionally during contacting, closed end 14 of tube 10 may be heated, however, end 14 is not required to be heated during the contacting step to practice this method of the invention. Also, during contacting, tube 10 may be rotated, however, tube 14 is not required to be rotated during contacting to practice this method of the invention. In the case that tube 14 is rotated during contacting, preferably, tool 30 is rotated in the same direction and the same speed as tube 10 during contacting.

It is preferred that after the contacting step, tube 10 has at least one exterior surface which has substantially the same appearance as an exterior surface of tool 30. Preferably the contacting step will result in end 14 assuming substantially the same shape as forming end 36 of tool 30. As shown in FIG. 3, end 18 and tip 20 have substantially the same shape as end 38 and tip 40 of the forming tool. Preferably end 18 has a substantially conical shape. Preferably, the step of contacting comprises transitioning an interior surface of closed end 14 of tube 10 from substantially symmetrical about an axial centerline of tube 10 to substantially non-symmetrical about the axial centerline. As shown in FIGS. 2 and 3, closed end 14 is transformed from substantially spherical to substantially non-spherical.

Additionally the method may include manipulating tip 20 to form a preferably non-circular orifice 22. Once orifice 22 is complete, crucible 24 is formed. As shown in FIG. 4, orifice 22 has a rectangular shape. In one embodiment of crucible 24, orifice 22 has an aspect ratio of at least about 2.5:1, preferably the aspect ratio comprises at least about 1.5:1, and more preferably the aspect ratio comprises at least about 3:1, and most preferably at least about 6:1. In another embodiment of crucible 24, orifice 22 has at least one dimension as small as about 0.5 mm. Orifice 24 dimensions may range from about 0.5 mm to about 16 mm. Preferred examples of the dimensions of a substantially rectangular shape orifice include about 0.5 mm×about 3.0 mm and about 6.0 mm×about 16 mm.

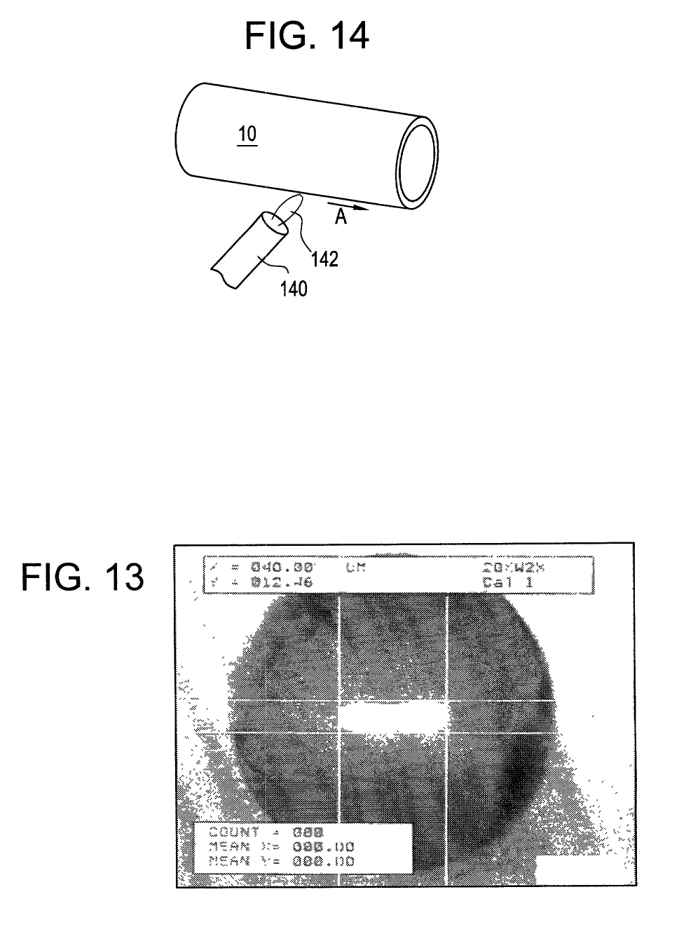

The shape of orifice 22 is not limited to a substantially rectangular shape. Orifice 22 can be any shape. Most preferably, orifice 22 has a non-circular shape. However, the invention is not limited to orifice 22 having a non-circular shape. Orifice 22 may have a circular shape. A non-exhaustive list of examples of shapes of orifice 22 include square, polygonal, star, circular, “D”-shaped, crescent, peanut or substantially FIG. 8 shaped (as shown in FIG. 13), and elliptical.

The step of manipulating tip 20 may comprise at least one method selected from grinding, laser cutting, water jet cutting, picking, polishing, core drilling, and combinations there of. Grinding as used above includes at least a process in which a grinding wheel, belt, cylinder, or stone having small abrasive particles imbedded therein is used to accomplish material removal. Orifice 22 is can be formed by contacting tip 20 of tube 10 with one of the above grinding devices.

Water jet cutting comprises cutting tip 20 with water alone or water with abrasives. Water jet cutting includes forcing ultrahigh pressure water (e.g. up to about 55,000 psi) through a small nozzle, e.g. as small as 0.004″ in diameter or 0.005″×0.16″, thereby generating a high-velocity water jet. The water leaving the nozzle may travel at a rate of speed as fast as three times the speed of sound. The water jet leaving the nozzle is a controllable cutting stream. The cutting stream is directed toward tip 20 of tube 10 to cut away the necessary material to form orifice 22.

In laser cutting a highly coherent, focused beam of light is used as a drill bit. The beam of light is used to heat tip 20 of tube 10 to above its softening point and vaporize the material necessary to form orifice 22.

Core drill is similar to grinding in that a grinding wheel is attached to a drill as a drill bit. The grinding wheel attached to the drill is used to remove the necessary material from tip 20 to form orifice 22.

Picking includes heating the section of tip 20 to above the softening temperature. Optionally air may be blown into tip 20 to create a bump on tip 20. A piece of glass cane is heated and then used to thin out the section of tip 20 with the bump. The hot cane is repeatedly plunged against the section of tip 20 to be thinned until; tip 20 is thinned sufficiently to create orifice 22.

An example of one embodiment of to form orifice 22 includes preferably grinding crucible 10 with tip 20 (as shown in FIG. 3) perpendicular to the axial centerline of crucible 10. Preferably, crucible 10 is held in a fixture to maintain crucible 10 square to the grinding apparatus.

A preferred grinding apparatus is a lap plate. Orifice 22 may be formed in tip 20 by grinding tip 20 with an 400 grit abrasive pad within about 0.1 of mm of the predetermined dimensions for tip 20. A magnifying eyepiece with a measurement device may be used to determine the dimensions of the orifice during grinding. Edmund Scientific of Tonawanda, N.Y. is one source of a magnifying eyepiece with a measurement device. Another suitable device may be a measuring microscope.

Once orifice 22 is within about 0.1 mm of the predetermined dimensions, an 800 grit abrasive pad is used to remove the remaining 0.1 mm of glass from orifice 22. Once the dimensions of orifice 22 have been achieved, orifice 22 is polished with a 1200 grit abrasive pad and subsequently with a 1600 grit abrasive pad. The polish set removes any visible scratches from the surface of orifice 22. Polishing results in removing any irregularities from the orifice dimensions, improves glass flow, and removes large particles which may have been deposited during previous grinding with coarser grinding pads. The polishing should not result in any noticeable change in orifice dimensions. Preferably orifice 22 that is formed is square with crucible 24.

Optionally, crucible 24 may be cleaned after orifice 22 has been formed. Preferably cleaning steps include, cleaning crucible 24 ultrasonically in the presence of a detergent. A preferred detergent is Micro 90 Cleaning Fluid. The cleaning step may include a second ultrasonic cleaning, preferably in the presence of an acidic solution. A preferred acidic solution may include up to about ten (10%) percent HF and up to about ten (10%) HNO₃.

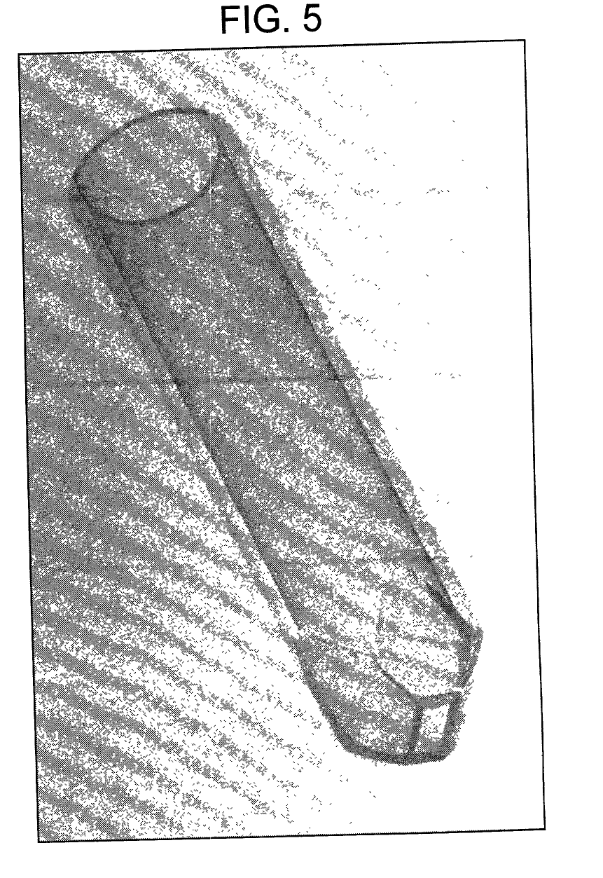

The above method can be made to produce a glass crucible as shown in FIG. 5. Crucible 24 of FIG. 5 includes a substantially rectangular orifice 22 and an open end 26, opposite orifice 22.

Optionally, the method may include the step of venting an atmosphere inside the tube. Preferably, the venting step occurs during the contacting step.

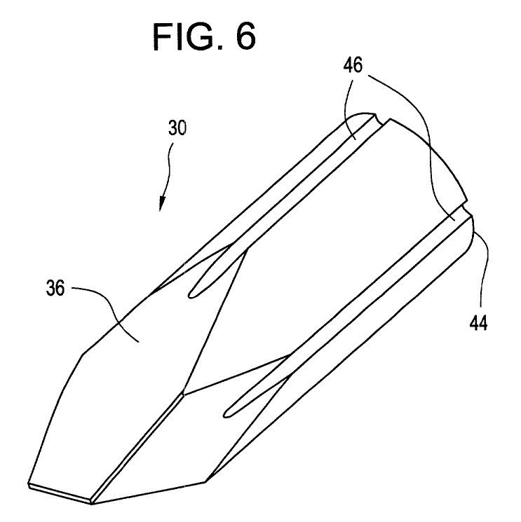

Preferably, the atmosphere is vented away from closed end 14 of tube 10. In one embodiment of the invention, tool 30 may include at least one annular passage 42 which will allow the atmosphere inside tube 10 to pass through tool 30 as tool 30 is brought into contact with closed end 14 of tube 10. Preferably, tool 30 includes more than one of the annular passage 42. More preferably, annular passage 42 will start on end 36, more preferably surface 38, and extend to an exit end 44 of tool 30, as shown in FIG. 3. In a second embodiment of tool 30, as shown in FIG. 6, at least one exterior surface of tool 30 may include a recessed portion 46 for venting the atmosphere inside tube 10. Preferably, the recessed portion will extend from end 36, more preferably surface 38, to exit end 44. Preferably tool 30 has more than one recessed portion 46.

Optionally, during the contacting step, closed end 14 may be heated. Another optional step includes pre-heating tool 30. Preferably, tool 30 is preheated to at least 300° C., more preferably at least 400° C., and most preferably no more than about 750° C. Preferably, the pre-heating of tool 30 takes place prior to the contacting step.

An advantage of making a crucible from a low thermal expansion material, such as quartz glass, in accordance with the inventive method of making a crucible is that the method does not require crucible 24 or tube 10 to be annealed before, during, or after the process for manufacturing crucible 24. However, optionally, the crucible may be annealed after the manipulating step.

Crucible 24 of FIG. 5 may be used as one or more of the crucibles in a multiple crucible apparatus from which an optical fiber may be drawn. In one preferred embodiment of a multiple crucible arrangement, the inner most crucible has a circular orifice and the crucible adjacent the inner most crucible has a non-circular orifice as shown in FIG. 5 or another non-circular shaped orifice. The outer most crucible of the apparatus also has a circular orifice.

An optical fiber may be drawn from the above multiple crucible apparatus. Methods of how a multiple crucible apparatus may be used to draw an optical fiber are explained in the U.S. patent application Ser. No. 09/654,549 filed Sep. 1, 2000 to Anderson et al, and is incorporated herein by reference.

Applications for a multiple crucible apparatus, which include at least one crucible made in accordance with the present invention, include a fiber for a Yb laser and a Tm double clad fiber. The above invention may be used to draw a fiber having at least one clad section with the dimensions of about 33 μm×about 10 μm.

The invention may also be able to draw a cane from a multiple crucible apparatus. The cane may be drawn into a fiber or additional soot may be deposited onto the cane and to form an overcladded cane and the overcladded cane may be drawn into a fiber. A cane made in accordance with the invention may also be used in a rod-in-tube technique for manufacturing an optical fiber.

With respect to drawing a cane from a multiple crucible apparatus instead of a fiber, the size of the orifices of the crucibles of the multiple crucible will be larger than the orifices of the crucibles for drawing an optical fiber. Also, the cane may be drawn at a lower temperature than a temperature at which a fiber is drawn. The cane may be drawn at a temperature of about 200 to about 600° C. lower than the temperature at which a fiber is drawn, preferably about 400° C. lower.

### EXAMPLES

The following examples are provided to illustrate embodiments of the present invention, but they are by no means intended to limit its scope.

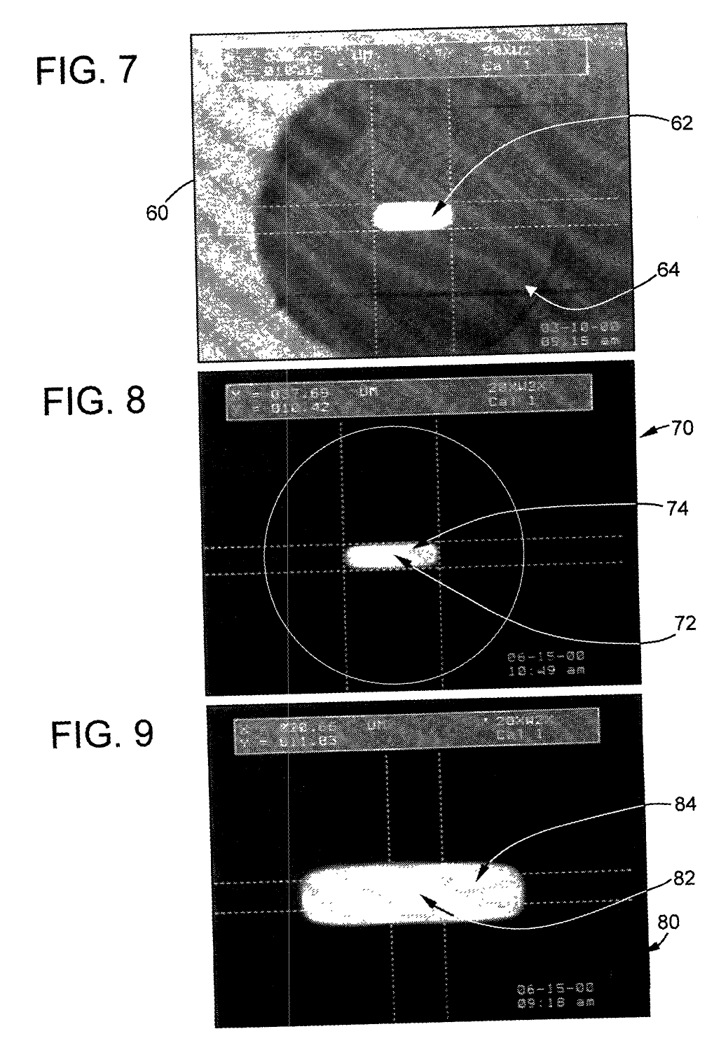

FIGS. 7-9 represent optical fibers or canes that were drawn from a multiple crucible apparatus, as described in U.S. patent application Ser. No. 09/654,549 incorporated by reference above. The apparatus includes at least one crucible made in accordance with the invention, as shown in FIG. 5. The multiple crucible apparatus was disposed in a draw furnace and the furnace was operated at a temperature of about 1350° C. to about 1450° C. The raw material for each portion of the drawn fiber was boro-silicate glass. Preferably, a cladding portion of each fiber immediately adjacent the core of each fiber was boro-silicate glass doped with Ytterbium (Yb). Each fiber was drawn at a rate of about 5 m/min to about 30 m/min. Preferably each fiber was drawn at a rate of about 10 m/min to about 20 m/min, more preferably about 15 m/min. The fiber cross sections shown in FIGS. 7-9, were taken and analyzed as explained in U.S. patent application Ser. No. 09/654549.

Each cross section of the sample shown in FIGS. 7-9 included at least one non-circular section. As illustrated in FIG. 7, the fiber 60 is a two glass system. The fiber included a substantially elliptical core 62 at the center of the cross-hairs and a circular outer cladding 64. The outer diameter of cladding 64 was about 125 μm. As shown in FIG. 7, the fiber included a non-circular core section 62 with the approximate dimensions of about 30 μm×about 10 μm. In the case of FIG. 7, core 62 of fiber 60 was drawn from a crucible made in accordance with the invention.

As shown in FIG. 8, the fiber 70 has a substantially rectangular cladding 74 adjacent a core 72. The cladding 70 has the dimensions of about 36 μm×about 10 μm. Illustrated in FIG. 9 is a cane 80 drawn from a multiple crucible apparatus. The cane has a core 82 and a substantially rectangular cladding 84 adjacent core 82. The cane 80 may be further processed as indicated above.

It will be apparent to those skilled in the art that various modifications and variations can be made to the present invention without departing from the spirit and scope of the invention. Thus, it is intended that the present invention covers the modifications and variations of this invention provided they come within the scope of the appended claims and their equivalents.

What is claimed is:

1. A method of forming a crucible comprising:
(a) bottoming one end of a tube thereby forming a substantially closed end;
(b) heating the closed end to a forming temperature;
(c) contacting an interior surface of the closed end with a forming tool, thereby altering the interior surface of the closed end to form at least one section with a predetermined wall thickness; and
(d) manipulating the at least one section of the closed end to form an orifice.

2. The method of claim 1, wherein said contacting comprises rotating the tube and the forming tool.

3. The method of claim 1, wherein said forming temperature comprises a temperature of at least a glass softening temperature for a material of construction of the tube.

4. The method of claim 1, wherein a time period for said contacting step comprises less than about 10 seconds.

5. The method of claim 1, wherein the orifice has an aspect ratio of at least about 1.5:1.

6. The method of claim 5, wherein the aspect ratio comprises at least about 3:1.

7. The method of claim 1, wherein the forming tool comprises a thermal conductive material which will remove heat from the tube during said contacting step.

8. The method of claim 1, wherein the step of manipulating comprises at least one method selected from grinding, laser cutting, polishing, water jet cutting, picking, core drilling, and combinations thereof.

9. The method of claim 1, wherein the forming tool comprises a base portion comprised of a first material of construction and a second portion comprised of a second material of construction.

10. The method of claim 1, furthering comprising forming the crucible without annealing the crucible.

11. The method of claim 5, wherein the aspect ratio comprises at least about 6:1.

12. The method of claim 1, wherein the forming tool comprises at least one surface capable of venting an atmosphere inside the tube during said contacting.

13. The method of claim 12, wherein the surface comprises at least one passage through the forming tool.

14. The method of claim 1, further comprising drawing heat away from the tube.

15. The method of claim 1, further comprising venting an atmosphere in the tube away from the closed end.

16. The method of claim 1, wherein the orifice has at least one dimension as small as about 0.5 mm.

17. The method of claim 1, wherein said orifice comprises a substantially rectangular shape.

18. The method of claim 1, wherein said orifice comprises a substantially elliptical shape.

19. The method of claim 1, wherein said step of contacting comprises transitioning the closed end of the tube from substantially symmetrical about an axial centerline of the tube to substantially non-symmetrical about the axial centerline of the tube.

20. The method of claim 1, further comprising not heating the closed end during said contacting step.

21. The method of claim 1, further comprising pre-heating the forming tool to at least about 300° C. prior to said step of contacting.

22. The method of claim 1, wherein a material of construction of the forming tool comprises graphite, platinum, alloys of platinum, alumina, zirconia, ceramics, or combination thereof.

23. A glass crucible formed in accordance with claim 1.

24. The method of claim 1, wherein an inner diameter of the tube comprises no more than about 5% more than an outer diameter of the forming tool.

25. A method of forming a crucible comprising:
(a) bottoming one end of a tube thereby forming a substantially closed end;
(b) heating the closed end to a forming temperature;
(c) pre-heating a forming tool to at least about 300° C. prior;
(d) contacting an interior surface of the closed end with a forming tool, thereby altering an interior surface of the closed end to form at least one section with a predetermined wall thickness;
(e) venting an atmosphere in the tube away from the closed end; and
(f) manipulating the at least one section of the closed end to form an orifice.

26. A method of forming a crucible comprising:
(a) bottoming one end of a tube thereby forming a substantially closed end;
(b) heating the closed end to a forming temperature;
(c) contacting an interior surface of the closed end with a forming tool having a non-circular tip, thereby altering the interior surface of the closed end to form at least one section with a predetermined wall thickness; and
(d) manipulating the tip of the closed end to form an orifice.

27. A method of making an optical fiber having a section with a non-circular cross section comprising drawing at least a section of a fiber from a crucible made in accordance with claim 1.

28. The method of claim 1 wherein the forming tool comprises a non-circular tip.

29. The method according to claim 1 wherein a shape of the orifice comprises a non-circular shape.

30. The method according to claim 1 wherein said contacting comprises rotating the tube and the forming tool, plunging the tool into the closed end of the tube while both the tube and the tool are not rotating, removing the tool from the closed end, and rotating the tube after said removing.

31. The method of claim 1 wherein said contacting comprises heating the at least one section of the closed end of the tube.

32. The method of claim 1 further comprising plunging a second forming tool with a nipple into the closed end prior to step (c).

33. A method of making an optical fiber having a section with a non-circular cross section comprising drawing at least a section of a cane from a crucible made in accordance with claim 1.
